(19) United States
(12) Patent Application Publication
(10) Pub. No.: US 2023/0221557 A1
(43) Pub. Date: Jul. 13, 2023

(54) Optical see-through head-mounted lightfield displays based on substrate-guided combiners

(71) Applicant: Arizona Board of Regents on Behalf of The University of Arizona, Tucson, AZ (US)

(72) Inventors: Hong Hua, Tucson, AZ (US); Miaomiao XU, Tucson, AZ (US)

(21) Appl. No.: 17/927,332

(22) PCT Filed: May 24, 2021
(86) PCT No.: PCT/US21/33829

§ 371 Date: Nov. 22, 2022

Related U.S. Application Data
(60) Provisional application No. 63/030,961, filed on May 28, 2020.

(51) Int. Cl. G02B 27/01; G02B 30/10; F21V 8/00

(52) U.S. Cl. CPC G02B 27/0172; G02B 30/10; G02B 6/005; G02B 2027/0134; G02B 2027/0123

(57) ABSTRACT

A head-mounted lightfield display including a lightfield rendering unit, a numerical aperture (NA) expander for receiving an optical output from the lightfield rendering unit and for creating an expanded lightfield, and a substrate-guided optical combiner optically coupled to the NA expander for receiving the expanded lightfield and transmitting the expanded light field to an eyebox for viewing by a user.

### RELATED APPLICATIONS

This application of claims the benefit of priority of U.S. Provisional Application No. 63/030,961, filed on May 28, 2020, the entire contents of which application(s) are incorporated herein by reference.

### FIELD OF THE INVENTION

The present invention relates generally to head-mounted displays (HMD), and more particularly, but not exclusively, to head-mounted lightfield displays (LF-HMD) having substrate-guided combiners.

### BACKGROUND OF THE INVENTION

Conventional stereoscopic displays enable the perception of a 3D scene via a pair of two-dimensional (2D) perspective images, one for each eye, with binocular disparities and other pictorial depth cues. However, such displays typically lack the ability to render correct retinal blur effects and stimulate natural eye accommodative responses, which leads to a vergence-accommodation conflict (VAC) problem. Several display methods that are potentially capable of rendering focus cues and overcome the VAC problem include volumetric displays, holographic displays, multi-focal-plane displays, Maxwellian view displays, and lightfield displays. Among these methods, an integral-imaging-based (InI-based) lightfield display is able to reconstruct a 3D scene by reproducing the directional rays apparently emitted by 3D points of different depths of the 3D scene, and therefore is capable of rendering correct focus cues similar to natural viewing scenes.

Although existing work has demonstrated the potential capabilities of a LF-HMD system for rendering focus cues and therefore addressing the VAC problem in conventional stereoscopic displays, existing LF-HMD prototypes offering optical see-through capabilities rely upon conventional optical combiners, such as a flat beamsplitter or a freeform beamsplitting surface and are generally bulky and heavy. An optical combiner, which combines the displayed virtual images with the real world scene, is a key optical element in the state-of-the-art optical see-through HMDs (OST-HMD). The present inventors have recognized that among the different technologies for optical combiners, waveguide and lightguide optics are promising solutions to optical combiners due to their small volume, light weight and relatively high efficiency. Waveguide and lightguide optics propagate the light rays from a virtual image by total internal reflection (TIR) in a thin, transparent substrate, and utilize couplers at both ends of the substrate to couple in and extract out the virtual images. Thus, integrating waveguide or lightguide optical combiners to LF-HMD systems can offer an opportunity to achieve both a compact optical see-through capability required for augmented reality (AR) and mixed reality (MR) applications and to achieve a true 3D scene with correct focus cues required for mitigating the VAC problem. However, due to the non-sequential ray propagation nature of waveguide and lightguide combiners and the ray construction nature of a lightfield display engine, however, adapting waveguide and lightguide combiners to a lightfield display engine poses several significant challenges. The key challenges are to efficiently couple out all elemental views which render a scene lightfield with a limited aperture size and to minimize image artifacts with a discrete out-coupler arrangement. Hence, it would be an advance in the state of the art to provide HMD systems that integrate waveguide or lightguide optical combiners to LF-HMD systems, and particularly to efficiently couple out all elemental views of a lightfield scene with a limited aperture size and to minimize image artifacts with a discrete out-coupler arrangement.

### SUMMARY OF THE INVENTION

In one of its aspects, the present invention provides designs of optical see-through head-mounted lightfields displays based on lightguide and waveguide combiners and provides methods to address the challenge of coupling lightfields through a guided substrate by incorporating a numerical aperture expander. (As used herein, the terms “lightguide combiner” and “waveguide combiner” are used interchangeably to refer to the same types of structures.) In another of its aspects the present invention may provide systems and methods that combine an integral-imaging-based lightfield display engine with a geometrical lightguide based on microstructure mirror arrays. The image artifacts and the key challenges in a lightguide-based LF-HMD system are systematically analyzed and are further quantified via a non-sequential ray tracing simulation. Several embodiments of the proposed designs and methods have been implemented and experimentally validated.

The present invention may provide a head-mounted lightfield display, including a lightfield rendering unit having microdisplay and a central depth plane (CDP) disposed at a location optically conjugate to the microdisplay to provide an output optical lightfield centered at the CDP; a numerical aperture (NA) expander disposed at or proximate the CDP to receive the output optical lightfield and transmit the output optical lightfield therethrough to provide an expanded lightfield at an output of the NA expander; and a substrate-guided optical combiner optically coupled to the NA expander and configured to receive the expanded lightfield and configured to transmit the expanded light field to an output thereof for viewing by a user. The lightfield rendering unit may include an integral-imaging-based lightfield display engine, and may include a micro-lenslet array (MLA) disposed between the microdisplay and the CDP; the MLA may be configured to make the microdisplay optically conjugate to the CDP. The NA expander may include a one or more of a diffuser, a holographic optical element, a diffractive optical element, and a polymer dispersed liquid crystal. The NA expander may be switchable and/or may be movably disposed at the CDP in a direction along the optical axis. The NA expander may include a plurality of stacked diffusers, a switchable beam deflector and/or a Pancharatnam-Berry phase deflector. A collimator may be disposed between the NA expander and the substrate-guided optical combiner to transmit the expanded lightfield from the NA expander to an input of the substrate-guided optical combiner. The collimator may include optics configured to magnify the output optical lightfield and image the output optical lightfield scene into visual space. The output optical lightfield may be a reconstructed 3D volume. The substrate-guided optical combiner may include an in-coupler, a guiding substrate, and an out-coupler. One or more of the in-coupler and the out-coupler may be one or more of a diffractive optical element (DoE), a holographic optical element (HoE), a reflective or partially reflective optical element (RoE), and a refractive element.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates an exemplary configuration of a proposed schematic layout of an optical see-through head-mounted lightfield display based on a substrate-guided optical combiner in accordance with the present invention;

FIGS. 2A-2B schematically illustrate exemplary configurations of two potential image artifacts in an InI-based MMA lightguide, showing ray path diagrams of two elemental views of a reconstruction point P, in which ray path splitting arises (FIG. 2A) and in which elemental view missing arises (FIG. 2B);

FIG. 2C illustrates a camera captured image with an image at infinity (left) and an image at 3 diopters (3D) where an image ghost arises due to ray path splitting (right);

FIG. 2D illustrates a camera captured image when all elemental images are displayed (left) and when elemental views are lost (right), for three sets of a Snellen chart InI with 3×3 views are rendered at 0.6 diopters away;

FIG. 3 schematically illustrates an exemplary layout of an InI-engine where a 3D point is rendered (e.g. 3×3 views in figure) and reconstructed at the central depth plane (CDP) and illustrates the footprint fill factor on the in-coupler surface P_{fp}≤1;

FIG. 4 schematically illustrates an exemplary layout in accordance with the present invention of a proposed InI-engine with a NA expander inserted on the reconstruction plane, making the fill factor P_{fp}>1 on the exit pupil of the collimator;

FIG. 5 schematically illustrates an exemplary layout in accordance with the present invention of a proposed InI unit with a NA expander placed on a motorized stage proximate the reconstruction plane, with the position of the NA expander fast translated within the reconstructed image volume, and the diffusing state of the NA expander optionally switched corresponding to the rendered scenes, making the fill factor P_{fp}>1 on the exit pupil of the collimator while maintaining high image resolution;

FIG. 6 schematically illustrates an exemplary layout in accordance with the present invention of a proposed InI unit with a NA expander containing multiple layers of expansion components (N=2 for the purpose of illustration) inserted at the reconstruction plane, with the stacked expander layers optionally able to fast switch between diffusing and transparent state corresponding to the rendered scenes, making the fill factor P_{fp}>1 on the exit pupil of the collimator while maintaining high image resolution;

FIG. 7A schematically illustrates an exemplary layout in accordance with the present invention of a proposed InI unit in which a switchable beam deflector is inserted at the reconstruction plane as a NA expander;

FIGS. 7B-7C schematically illustrate a switchable beam deflector in accordance with the present invention in transmission mode and reflective mode, respectively, where the switchable beam deflector may be a reflective or transmissive type, with the function of deflecting the input beam direction toward different directions through the control of an electrical field, making the fill factor P_{fp}>1 on the exit pupil of the collimator while maintaining high image resolution;

FIG. 8 schematically illustrates an exemplary layout in accordance with the present invention of a proposed schematic layout of an optical see-through head-mounted lightfield display with NA expander based on a substrate-guided optical combiner;

FIGS. 9A-9C illustrate simulation results of the number of ray paths (image points) and power distributions under different P_{fp}, with FIG. 9A showing the number of out-coupled ray paths (image points) from each ray bundle when P_{fp} equals 1, 3.71 and 5.61, the three elemental ray bundles labeled in different shades, FIG. 9B showing the statistical distribution of the number of image points coupled out when the footprint fill factor P_{fp} varies as in Table 1, and with FIG. 9C showing the power ratio of the out-coupled image point with the highest power to the overall out-coupled power of each elemental view when P_{fp} equals 1, 3.71 and 5.61;

FIG. 10A illustrates an angular distribution of the number of the primary image points in visual space when P_{fp} equals 1, 3.71 and 5.61;

FIG. 10B illustrates a statistical distribution of the number of elemental views (despite ghost images) seen through the eyebox in visual space across FOV;

FIG. 10C illustrates the statistical distribution of overall image points seen through the eyebox (including primary and ghost image points) as a function of FOV in visual space when P_{fp} varies as in Table 1;

FIGS. 11A, 11B, illustrates a retinal image simulation of the InI-based MMA lightguide in accordance with the present invention, with FIG. 11A showing the original input image with the image rendered on the CDP plane and FIG. 11B showing the simulated retinal images when P_{fp} varies from 1 to 7.07;

FIG. 12A illustrates a prototype that was fabricated in accordance with the present invention including an InI-based MMA lightguide having an engineered diffuser as the NA expander;

FIG. 12B schematically illustrates an exemplary configuration of an electrical-switching PDLC film in accordance with the present invention with a diffusing (top) and transparent (bottom) state, later adopted as NA expander;

FIG. 13A illustrates an array of elemental images displayed on the microdisplay of the prototype of FIG. 12A when rendering three sets of Snellen charts at 0.6 diopters with 3×3 views;

FIGS. 13B-13D variously illustrate the captured out-coupled images of the InI-LG with no diffuser and a 5 deg, 10 deg, 15 deg or 30 deg FWHM engineered diffuser inserted at the CDP, where the white rectangle shows the dark fields with all elemental views missing;

FIGS. 14A, 14B illustrate images captured when three targets at 0.01D, 0.6D and 3D were rendered by the InI-engine with an MP1 as the NA expander in accordance with the present invention, in which the back PDLC layer was in diffusing state and the front PDLC layer was in transparent state (FIG. 14A) and in which the back PDLC layer was in transparent state and the front PDLC layer was in diffusing state (FIG. 14B), with camera focusing changed corresponding to the reconstruction depths of three targets and with the exposure maximized; and

FIGS. 15A, 15B illustrate images captured when three targets at 0.01D, 0.6D and 3D were rendered by the InI-engine with MP2 as NA expander in accordance with the present invention, in which the back PDLC layer was in a diffusing state and the front PDLC layer was in a transparent state (FIG. 15A) and in which the back PDLC layer was in a transparent state and the front PDLC layer was in a diffusing state (FIG. 15B), with camera focusing changed corresponding to the reconstruction depths of three targets and with the camera exposure less than that in FIGS. 14A, 14B.

### DETAILED DESCRIPTION OF THE INVENTION

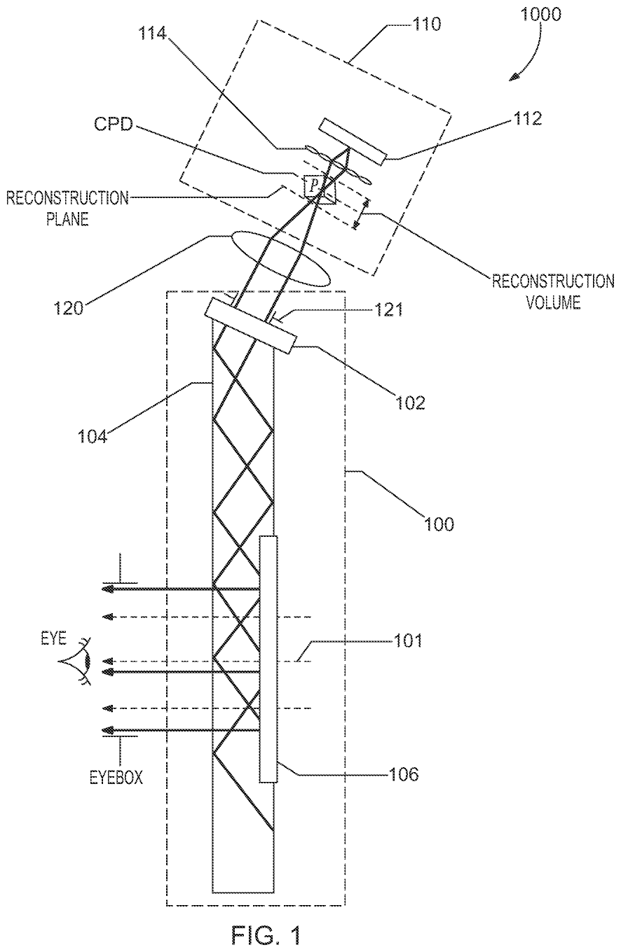

FIG. 1 schematically illustrates an exemplary layout of an optical see-through head-mounted lightfield display 1000 based on a lightguide or waveguide optical combiner in accordance with the present invention, which may include a lightfield rendering unit 110, an image collimator 120 (and/or imaging optics), and a substrate-guided optical combiner 100, such as a waveguide or lightguide. The lightfield rendering unit 110 can be based on any suitable technologies that render the perception of a 3D object (e.g. a cube) by reproducing the directional samples of the light rays apparently emitted by each point on the object such that multiple elemental view samples are seen through each of the eye pupils. Examples of such lightfield rendering technologies, include, but are not limited to, super multi-view displays, integral-imaging (InI) based displays, and computational multi-layer lightfield displays.

The lightfield rendering unit 110 in FIG. 1 may utilize an InI-based lightfield engine 110 as an example, which includes a microdisplay 112 and a micro-lenslet array (MLA) 114, which renders the lightfields of a 3D scene. The microdisplay 112 may render an array of elemental images (EIs) providing positional sampling of the 3D scene lightfield. Each EI may provide a perspective view of the 3D scene and may be imaged through a corresponding element of the MLA 114. The MLA 114 helps to generate directional views of the lightfield, through which the ray bundles from EIs enter into their corresponding microlenses 114 and integrate at their corresponding reconstruction planes to reconstruct the lightfield of a 3D scene. By changing the perspective contents of each EI, objects at different depths can be rendered. The collimator 120 and/or the imaging optics may magnify the reconstructed 3D volume from the lightfield rendering unit 110 (e.g., micro-InI unit) and image the 3D scene into visual space. The collimator 120 (and/or optional imaging optics) may be one or more of a singlet or doublet, a traditional rotational symmetry lens group, or monolithic freeform prism, for example. To maximize the image coupling efficiency of the system and to avoid light loss and vignetting, the exit pupil of the collimator 121 may be located at or near to an exterior surface of an in-coupler 102 of the substrate-guided optical combiner 100, such as lightguide or waveguide.

A substrate 104-guided optical combiner 100 of the present invention may include three functional parts: an in-coupler 102, a guiding substrate 104, and an out-coupler 106. The in-coupler 102 may help to couple the magnified lightfield from the collimator 120 into the guiding substrate 104. The images or ray bundles may then propagate through the guiding substrate 104 by total internal reflection (TIR), and may be coupled out toward the eyebox, where a viewer's eye is placed, via the out-coupler 106. The guiding substrate 104 can be flat or curved, with different shapes and structures. Substrate-guided optical combiners 100 used as in OST-HMDs, such as waveguides and lightguides, may be classified by the light-coupling mechanisms of the in-coupler 102 or out-coupler 106 technologies being utilized. Both the in-coupler 102 and out-coupler 106 may be provided as different configurations/devices, such as: a diffractive optical element (DoE); a holographic optical element (HoE); a metasurface; a reflective or partially reflective optical element (RoE); and/or, refractive elements with 1-dimensional or 2-dimensional structure, etched or engraved on different shapes of substrates (flat or curved) and configurations, for example. The out-coupler 106 may desirably have functions to enable both see-through path 101 and the virtual image path, such as using partially-reflective-partially-transparent structures, or HOEs. Substrate-guided optical combiners 100 of the present invention can be more generally classified into two types: holographic waveguides (of which couplers are diffractive or holographic optical elements based on physical optics propagation) and geometrical lightguides (of which couplers are reflective optical elements based on geometrical optics propagation).

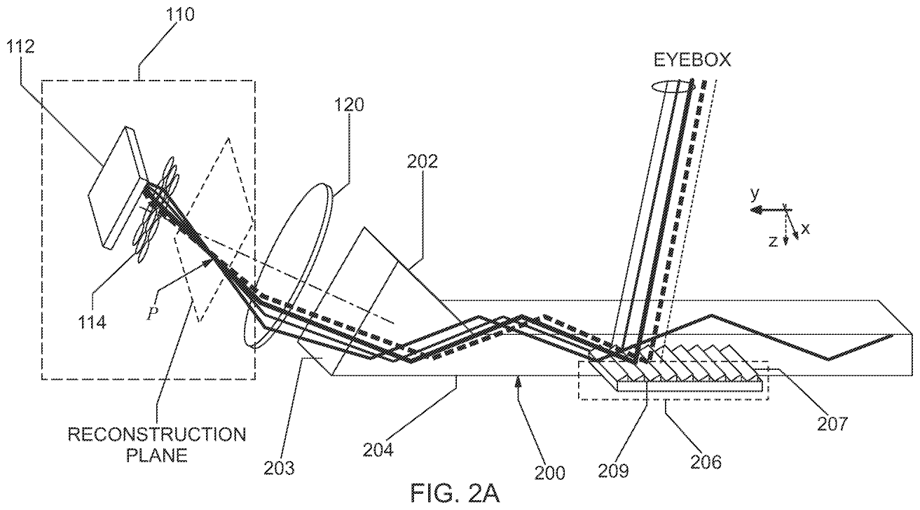

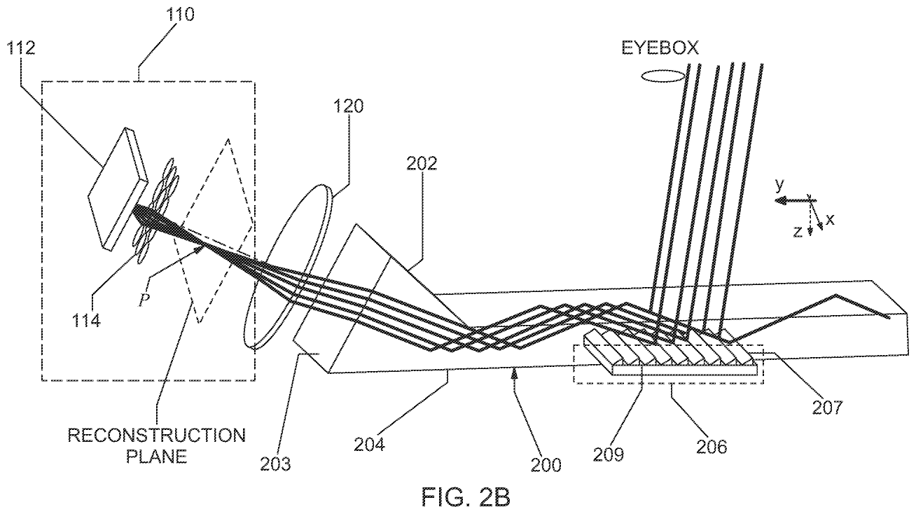

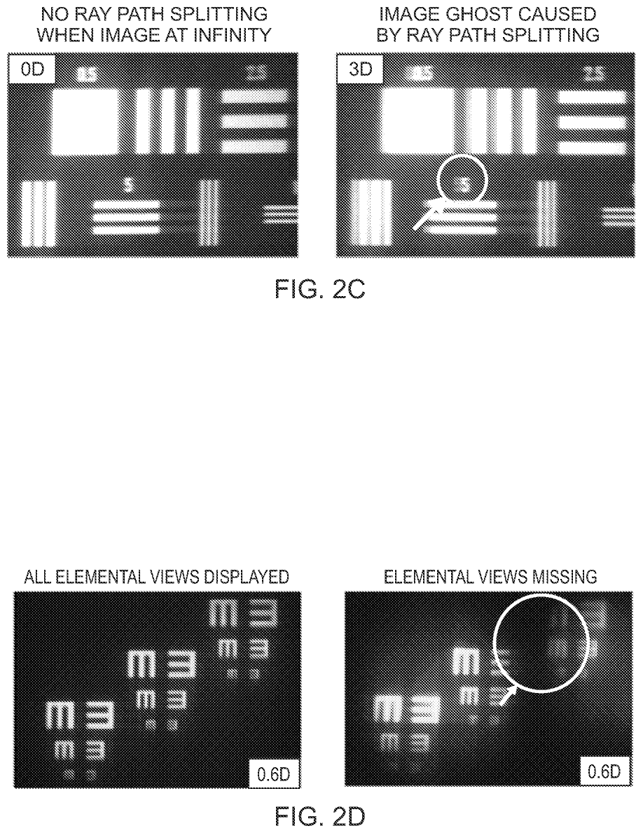

FIGS. 2A and 2B illustrate an exemplary configuration of integrating a micro-InI unit 110 with a micro-mirror-array-based geometrical lightguide 200 in accordance with the present invention. A micro-mirror-array (MMA)-based lightguide 200 may be divided into three functional segments: a wedge prism 202 as its in-coupler, a guiding substrate 204, and a micro-mirror array 206 as its out-coupler. As illustrated in FIGS. 2A and 2B, the in-coupling wedge 202, located at left end of the lightguide substrate 204, can be provided as an inverted right triangular prism with one right-angle side to be the in-coupling surface 203, which couples the light from the image collimator 120 into the lightguide substrate 204. The guiding substrate 204 may be the main bulk of the lightguide 200 and allows the in-coupled light to propagate toward the out-coupler 206 via multiple TIR reflections. The out-coupler area, located on the right end of the lightguide substrate 204, may be composed of a one-dimensional or two-dimensional array of micro-mirror structures 207 spaced apart by uncoated flat top regions 209. The in-coupled rays may be reflected toward the eyebox via the coated mirrors 207 while the in-coming light from a real-world scene is transmitted through the uncoated flat regions 209.

A 3D image point, P, may be reconstructed by multiple elemental ray bundles from pixels on adjacent EIs each of which renders a different perspective view. (An aperture array may be inserted between the microdisplay and the MLA to reduce image crosstalk between adjacent microlenses 114.) The miniature 3D scene generated by micro-InI unit 110 may then be magnified by the image collimator 120 and may be coupled into the MMA lightguide 200 through the wedge-shaped in-coupler 202. The ray bundles from the EIs are coupled into the lightguide substrate 204 by the in-coupler 202, propagate through the substrate 204 by TIR, and are coupled out by the MMA out-coupler 206 toward the eyebox.

When attempting to out-couple a 3D lightfield source through a lightguide 200 as shown in FIG. 2A, there are two important issues. The first issue relates to the image quality degradation and artifacts over the whole field of view (FOV) in geometrical lightguides with a finite or vari-focal depth. Due to the non-sequential ray propagation nature through the substrate 204 and the discrete out-coupling structures of the out-coupler 206, such as micro-mirror arrays, the ray bundles from the same pixel on a display source are usually split into multiple optical paths either by different numbers of total internal reflections (TIRs) or by different segments of the out-coupler 206, and are inherently subject to different optical path lengths (OPLs). The ray path splitting issue can induce ghost-like image artifacts and degrade the image quality. An example is shown in FIG. 2A, where an elemental ray bundle is split into three sub-ray paths (shown in different line weights) by three micromirrors 207 when the elemental ray bundle is coupled out through the eyebox. The ray path splitting does not affect the image performance when the central depth plane (CDP, FIG. 1), which refers to the optical conjugate to the microdisplay 112 by the MLA 144, of the micro-InI unit 110 is located at the front focal plane of the collimator 120. In such collimated condition, since all elemental ray bundles are collimated before being coupled into the lightguide 200, all sub-ray paths from an elemental ray bundle are coupled out by the same field angle. The collimated condition of the CDP, however, imposes significant compromise on the resolution and depth range of the reconstructed lightfield. It may therefore be preferred to place the CDP inside the front focal plane of the collimator 120. When the CDP is not at the front focal plane of the collimator 120, the elemental ray bundles are focused at a finite depth in the visual space, and the split sub-ray paths from an elemental ray bundle will form multiple image points in visual space due to the different OPLs, as demonstrated by the example in FIG. 2C.

The second issue affects the viewing density and uniformity of the out-coupled lightfield image and is a specific issue when implementing an InI-engine into an MMA lightguide, and is caused by the reduced footprint size of each elemental ray bundle of the InI-engine on the eye pupil. In an InI-based lightfield rendering system, a 3D point is rendered by several ray bundles emitted from multiple selected pixels of different EIs, and the individual ray bundles are projected into an array of spatially separate footprints on the exit pupil of the collimator lens 120 located on the in-coupling wedge surface 203. In this case, an elemental ray bundle representing a specific elemental view only occupies a small portion of the overall exit pupil, which causes some elemental views not to be coupled out through the eyebox. FIG. 2B shows a ray path diagram where an elemental ray bundle missed the eyebox when it is coupled out due to the limited footprint size of the input elemental ray bundle. As a result, some of the reconstructed elemental views and image contents are not visible through the eyebox after propagating through the lightguide 200. FIG. 2D shows a captured image through a 4 mm eyebox of the InI-based system in accordance with the present invention where the micro-InI unit 110 has rendered three sets of resolution targets with 3 by 3 views at 0.6 diopters away from the viewer. For the purpose of comparison, the left part of FIG. 2D shows a captured image directly at the exit pupil of the collimator 120 without using an MMA lightguide 200, where all the targets are properly reconstructed without missing EIs seen by the eye. The right part of FIG. 2D shows the captured image of out-coupled lightfields after implementing the MMA lightguide 200. It can be seen that several parts of the targets are not properly constructed with noticeable missing parts and degraded resolution. Some of the elemental views are not coupled out due to the mismatched footprint positions of these elemental ray bundles, while some parts of image contents in the circle are totally missing, since all the elemental views at these fields fail to be coupled out through the eyebox.

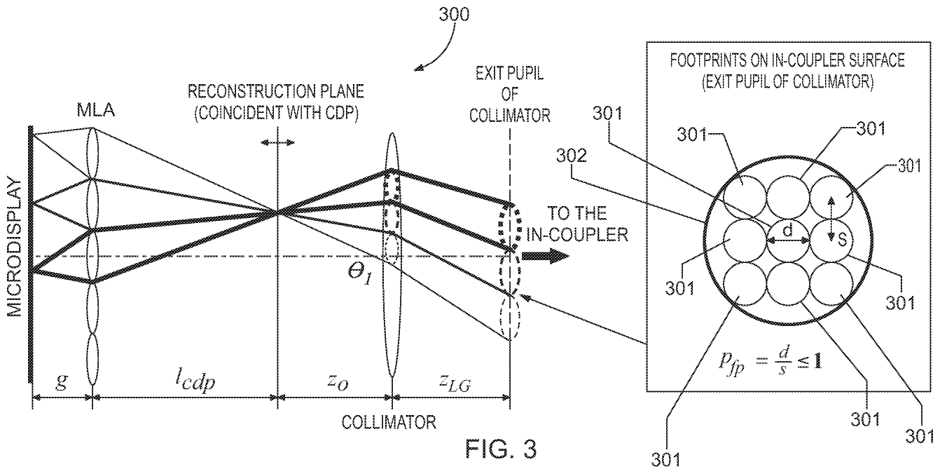

FIG. 3 schematically illustrates an exemplary layout of an InI-engine 300 in accordance with the present invention without implementing a lightguide combiner and shows the projected footprints 301 of elemental ray bundles at the exit pupil 302 of the collimator. In this illustration, an image point located on the central depth plane (CDP) is reconstructed by 3×3 elemental views. The footprint fill factor of an elemental view, P_{fp}, is defined as the ratio of the footprint diameter d of an elemental ray bundle to the central distance or pitch, s, between two adjacent views. In the example of FIG. 3, the fill factor of each elemental view is equal to 1. The P_{fp} typically ranges from 0 to 1, since it is limited by the arrangement of the MLA 114 and the NA of the ray bundles from the microdisplay. Typically, the constraint of P_{fp}≤1 limits the NA of an elemental ray bundle to be no higher than the NA of the MLA 114 to avoid the crosstalk from neighboring elemental views.

When coupling the rendered lightfield through a substrate-guided optical combiner 200, as demonstrated in the example of FIG. 2D, some of the elemental views fail to be out-coupled inside the eyebox and in severe situations a portion of the reconstructed content can be entirely lost from view, due to the substantially smaller footprint size of each elemental view on the in-coupling surface of the lightguide than on a non-lightfield display. To increase the out-coupling possibilities of elemental ray bundles through the eyebox and allow more elemental views to be seen, a possible solution is to increase the footprint size of each elemental ray bundle on the in-coupler 102, 202 of the lightguide. Directly increasing the NA of the micro-InI unit 110 (e.g. by decreasing the f-number of MLA 114) does not change the out-coupling uniformity of the EIs and can introduce more vignetting on the in-coupler wedge 202 of the lightguide 200, since it leads to the increased spacing, s, between adjacent views and thus the size of overall exit pupil and reduces the effective viewing density for a fixed size of eye pupil.

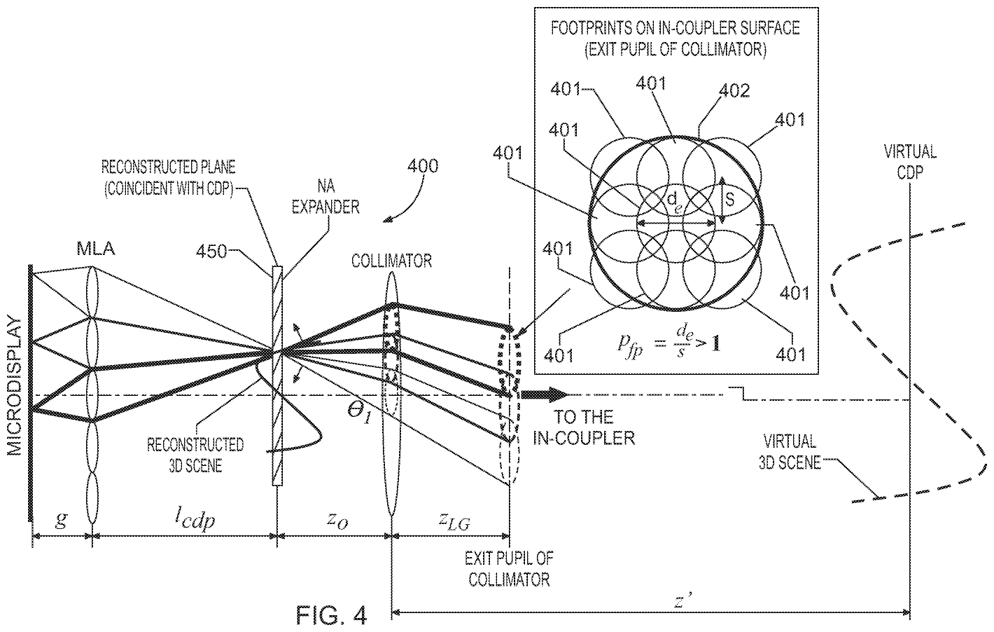

An alternative approach in accordance with the present invention is to increase the footprint fill factor, P_{fp}, of each elemental view by increasing its footprint size, d, while maintaining the same spacing and arrangement among adjacent views, so that the projected area of each elemental view can occupy a larger portion of the exit pupil and increase the out-coupling possibilities of the elemental views through the eyebox. FIG. 4 shows a schematic layout of an exemplary a approach in accordance with the present invention to increase P_{fp} without introducing crosstalk by adding a NA expansion component 500 at a reconstruction depth plane of the micro-InI unit. With a NA expander 450, such as a holographic diffuser, for example, inserted at the reconstructed image plane, the emitting angle of each elemental ray bundle originated from the reconstructed image point is expanded, which results in an increased projected footprint diameter dₑ on the exit pupil plane of the collimator without changing the footprint arrangement and pitch size s. With an increased footprint fill factor, the elemental ray bundles are more likely to be coupled out through the eyebox by the MMA out-coupler 206, which improves the effective viewing density and image uniformity of the out-coupled lightfield.

Based on the schematic layout in FIG. 4, the projected pitch size, s, of an elemental ray bundle on the exit pupil 402 of the collimator 120, which only depends on the micro-InI unit 400 and the collimator 120 and is not affected by the NA expander 450, can be calculated by

$$s = \frac{{N}_{view}}{( 1 + {N}_{view} ) \cdot f / {\#}_{MLA}} \cdot \frac{{z}_{0}}{{z}^{′}} \cdot ( {z}^{′} + {z}_{LG} ) \qquad ( 1 )$$

where N_{view} is the number of elemental views in vertical or horizontal direction of the reconstructed 3D scene, which equals the lateral magnification M_{MLA} of a lenslet in the MLA 114 on the CDP; f/#M_{LA} is the f-number of a lenslet in the MLA 114; z₀ is the distance from the collimator 120 to the reconstructed central depth plane (CDP) by the micro-InI unit 400, z′ is the distance from the collimator 120 to virtual CDP in visual space, where the virtual CDP is the optical conjugate depth plane of the reconstructed CDP through the collimator 120, and z_{LG} is the distance from the collimator 120 to the exit pupil plane 402. The z_{LG} equals the focal length of the collimator 120 to maintain object-space telecentricity, which reduces the size of the exit pupil as well as the crosstalk and image artifacts from adjacent EIs. The expanded diameter dₑ of footprints 401, which depends on the expanded NA, NAₑ, of the NA expander 450 as well as the collimator 120, can be calculated by

$${d}_{e} = \frac{2 {NA}_{e} \cdot {z}_{0}}{{z}^{′}} \cdot ( {z}^{′} + {z}_{LG} ) \qquad ( 2 )$$

where NAₑ=tan θ, θ is the half emitting angle of each elemental view after passing through the NA expander 450. From Eq. (1) and (2), the P_{fp} can be changed by varying the half emitting angle θ of the NA expander 450 and can be greater than 1, which allows the projected footprints 401 to overlap on the exit pupil 402 of the collimator 120 as illustrated in FIG. 4. For an InI-based MMA lightguide system, the value of P_{fp} should be determined by considering the tradeoffs between the effective viewing density of the out-coupled lightfield image and the image artifacts induced by the ray path splitting. Using high NAₑ diffusers with large P_{fp} can significantly increase the size of the footprints 401 of the elemental images and further increase the viewing density of the out-coupled lightfield image. However, more ray paths are generated at the out-coupler area, which induces severe image artifacts and degrades the image performance.

The NA expander 450 of FIG. 4 can comprise in various diffusing materials, configurations and structures. The material of the NA expander 450 should have the function of diffusing light to expand the incoming beam size, such as a diffuser, engineered diffuser, HoEs (holographic optical elements), DoEs (diffractive optical elements), polymer dispersed liquid crystals (PDLCs) and many others. The diffusive state of the NA expander 450 can be switchable or non-switchable, either binary (only switching between diffusing and transparent states) or multiple-valued. Notice that whether a diffusive state on the implemented NA expander 450 is switchable or not depends on the requirements for image quality, output efficiency, depth of field of the reconstruction lightfield and computation time or display fresh rate. There are tradeoffs between them: when the NA expander 450 includes a switchable function corresponding to the rendered lightfield image in 3-dimensional space, the image resolution is better and the output image efficiency is higher than non-switchable case, but at the cost of computational time, and it may require an electrically driven material or motorized stages, which can also increase the power consumption and cost. On the other hand, if a non-switchable NA expander 450 is adopted, there is no demand on computational time, switching speed or powers consumption, but the image resolution may degrade significantly as the reconstruction depth moves further away from the NA expander 450, the influence of which will highly depend on the depth of field of the InI unit and the resulted NA.

In one exemplary configuration in accordance with the present invention, the NA expander 450 can be a 2-dimensional (2D) thin plate at a fixed position as shown in FIG. 4. The diffusive state of the NA expander 450 can be switchable or non-switchable, but may be placed at a fixed axial position, typically coinciding with the CDP or the optical conjugate of the CDP depth, which is the optical image of the CDP plane formed through an optical element such as the collimator 120. For instance, a variety of light-shaping engineering diffusers with different diffusing angles can be used for this purpose. One example is the light shaping diffusers made by Luminit (St. Torrance, Calif., USA). Such light shaping diffusers can use surface relief structures that are replicated from a holographically-recorded master. The pseudo-random, non-periodic structure can shape light propagation direction with different NA expansion rate. The experiments demonstrated below used Luminit diffusers of different diffusing angles. Engineered diffusers fabricated by other engineering approaches are also available through other vendors such as RPC Photonics (Rochester, N.Y., USA). Other PDLC-based controllable diffuser technology such as those available from Kent Optronics (Hopewell Junction, N.Y., USA) or other vendors can also be utilized. When a single thin-layer diffuser is utilized as a NA expander 450, the diffuser should be placed at the location of the CDP to minimize additional image quality degradation for reconstructed scenes located near the CDP. Due to the diffusing nature of the micro-structures of a NA expander 450, these micro-structures are expected to introducing light scattering effects when the reconstruction depth is shifted away from the CDP. For this reason, the diffusing angle needs to be carefully chosen such that it expands the fill factor, P_{fp}, of the elemental views just adequate enough to allow most of the views to be coupled out. When the diffusing angle or equivalently the fill factor is excessively large, more ghost images will be produced when the elemental views are coupled out the substrate, and the depth range of the reconstructed 3D scene will be reduced. The simulation and the experimental results below demonstrate the effects of different fill factors. In order to maintain good image quality across a given reconstruction depth range, a general rule of thumb here is that the expanded fill factor shall ensure the footprint the expanded beam on the furthest limit of the reconstruction depth plane should be smaller than a blurring criterion acceptable to the performance specifications. For instance, a fill factor of P_{fp} about 5 is preferred for an embodiment of FIG. 4 to create a 3D reconstruction volume of at least 2 diopters for the prototype demonstrated.

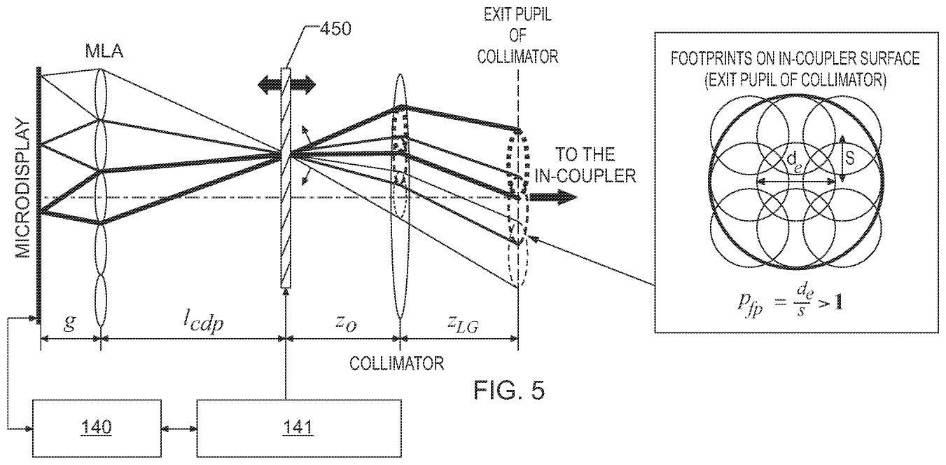

Alternatively, a single thin-layer NA expander 450 in FIG. 4 can be replaced by a NA expander 450 mounted on a movable stage 141 to allow its axial position to be dynamically adjusted, as shown in FIG. 5. One possible embodiment is to mount a light-shaping engineering diffuser on a light-weight motorized linear stage 141. The same type of diffusers as those used in FIG. 4 can be used here, but the depth position of the NA expander 450 may be dynamically controlled to match the depth of a given reconstruction depth. A significant advantage provided by a dynamic position match is the much less degradation of the reconstructed image quality when reconstructing objects located away from the CDP plane as the light scattering effects by the micro-structures of a NA expander 450 do not introduce additional blurring effects and do not vary with reconstruction depth as long as NA expander's position approximately matches the depth of reconstruction. In this sense, a NA expander 450 with a larger diffusing angle can be utilized or improved image quality and a larger depth range can be achieved with a motorized NA expander 450 of the same diffusing angle compared to a fixed expander. A variety of motorized stages 141 can be used to control the axial position of the NA expander diffuser 450. For example, a piezo actuator (model P-629.1CD) by Physik Instruments (PI) (Auburn, Mass., USA) can provide a travel range of 1.5 mm and very precise linear position control with a resolution of 3 nm and a repeatability of ±14 nm. Alternatively, a PI V-522.1AA compact linear motor and voice coil stage can be used, which offers a translation speed of 250 mm/s, a travel range of 5 mm, a resolution of 10 nm and a bidirectional repeatability of ±120 nm. There are also many other vendors for compact motorized linear stages 141 that can be used for this purpose. When combined with a motorized stage 141 controlled by a computer 140, the NA expander 450 can be placed at different depths away from the CDP plane in a time-sequential fashion. Each of the depth positions may correspond a sampled depth of the 3D reconstruction volume. The motorized stage 141 can operate in a relatively slow speed (e.g. about 20-120 Hz) where its axial position may be dynamically controlled by a computer 140 such that the corresponding depth of the NA expander plane in the visual space matches with the depth of interest rendered by the content displayed on a microdisplay 112. The depth of interest can correspond to the eye convergence depth of a viewer which can be determined through a gaze tracking device or other means. Alternatively, the motorized stage 141 can operate at a relatively fast speed (e.g. 120 Hz or higher) where its axial position may be dynamically switched between multiple depths or swept through the depth volume continuously at a speed faster than the critical flicker frequency of the human eyes. In this way, multiple depths of the reconstruction volume are sampled by the NA expander in time-multiplexed fashion and there is no need to match with the depth of interest.

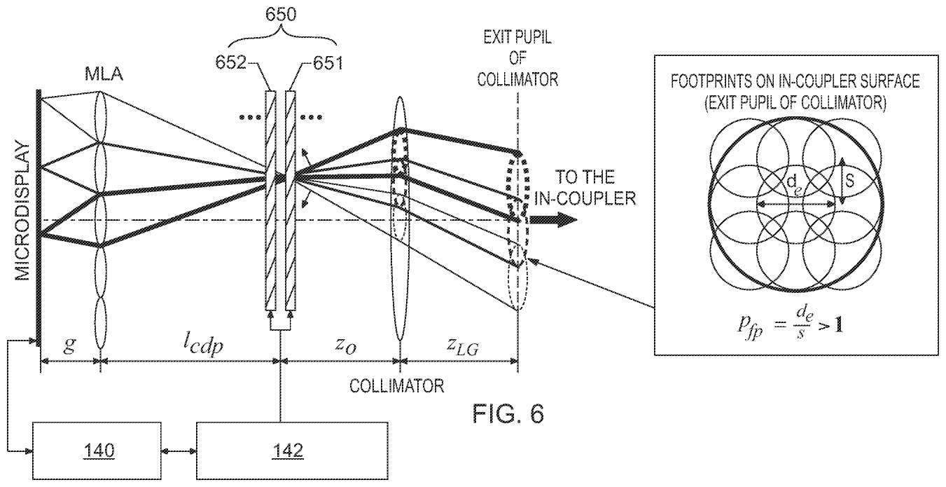

An alternative to a static NA expander 450 on a motorized stage 141 is shown in FIG. 6, where the dynamic position control of a NA expander 650 can be implemented by a stack of multiple-layer dynamically-controllable NA 651, 652 expanders. Each of the layers 651, 652 can be thought of providing NA expansion to the reconstructed lightfields located within a sub-volume of the reconstruction volume approximately centered on the depth location corresponding to the conjugate depth of the NA layer 651, 652. These layers 651, 652 can collectively provide the NA expansion to a large reconstruction volume. Each NA expander layer 651, 652 may be dynamically controllable by applying an electrical field of certain frequency through a controller 142. For instance, each layer 651, 652 can be switchable between diffusing and transparent states in a binary fashion or be continuously or discretely controlled between different levels of diffusing and transparent states. One possible choice of switchable NA expander 650 in accordance with the present invention is a polymer dispersed liquid crystal (PDLC) available from vendors such as Kent Optronics or LightSpace Technologies (Twinsburg, Ohio, USA). By stacking N-layers (N>1) of such PDLC films with small gaps in between, we can create a multi-layer dynamically-controllable NA expanders 650. Each of the PDLC layers 651, 652 can be digitally controlled by a computer 140 and switched between diffusing and transparent states. When a layer 651, 652 is turned to a diffusing state while other layers 651, 652 are turned to transparent states, NA expansion may be provided to the reconstructed lightfields located within a sub-volume of the reconstruction volume approximately centered on the depth location corresponding to the conjugate depth of the PDLC layer. The depth position of the PDLC layers 651, 652 depends on the small gaps between adjacent layers 651, 652. Through a synchronous control by a computer 140, the rendering depth of the reconstructed lightfield can be matched with the depth of the NA expander by selectively switching a given layer 651, 652 in the stack to a diffusing state while setting other layers 651, 652 to be transparent. The experiments below demonstrated the configurations of two different PDLC stacks from two different vendors and the specifications of the PDLC stacks are provided in Table 2 below.

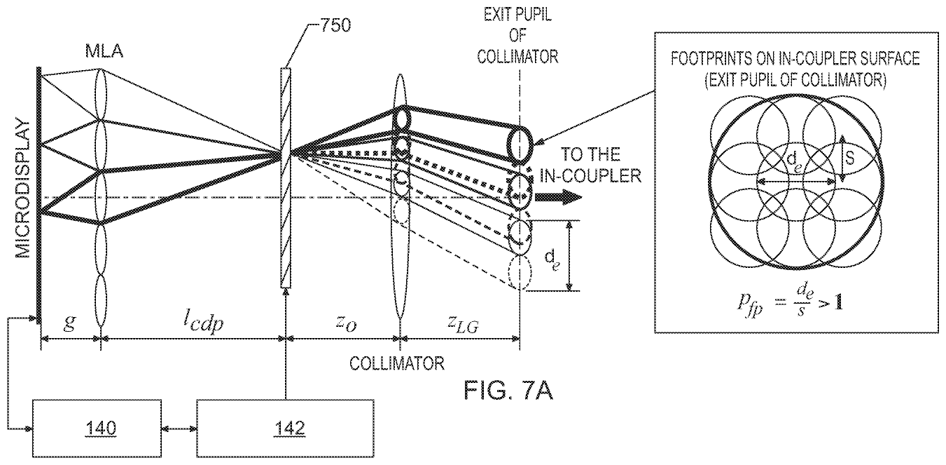

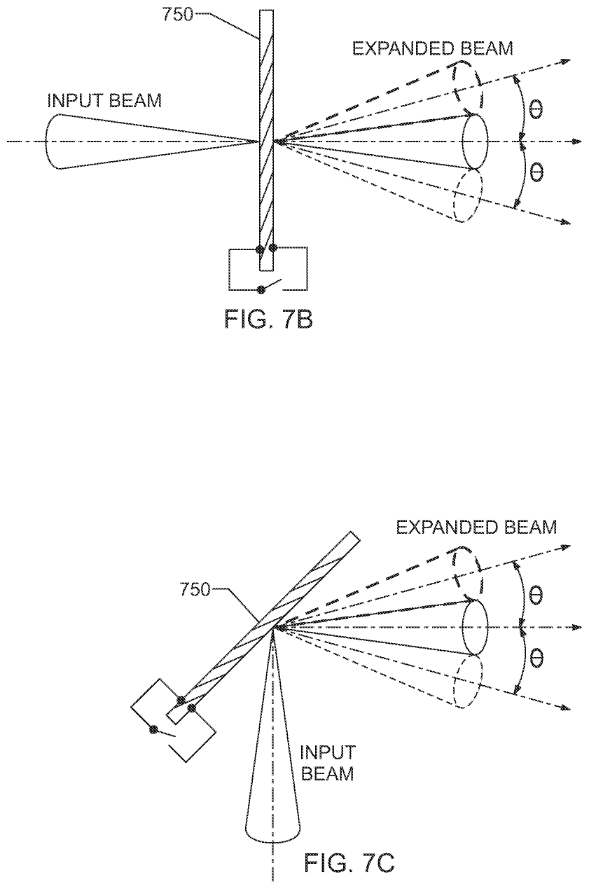

Instead of using an expander based on various diffusing materials as described above, the NA expander in FIG. 4 can also be implemented by a switchable beam deflector (SBD) 750, as shown in FIG. 7A. An SBD 750 can deflect the direction of an input beam by a small angle, θ, when an electrical field is applied to the device so that the output beam direction can be switched between multiple directions, as illustrated in FIGS. 7B and 7C in transmissive mode and reflective mode, respectively. By time-multiplexing these directions, the effective NA of the output beam may be expanded to be N times (N>1) greater than the NA of the input beam. Compared with the diffusion-based beam expansion methods above, a significant advantage of an SBD-based beam expansion is free of scattering-induced image artifacts and much less image quality degradation for reconstructing objects away from the CDP. One possible configuration of an SBD 750 is a switchable Pancharatnam-Berry phase deflector (PBD), which is a single-order phase grating. In a Pancharatnam-Berry (PB) phase optical element, a half-wave plate is spatially patterned with varying in-plane crystal axis direction and its phase modulation is then directly determined by the crystal axis orientation, namely the azimuthal angle of the liquid crystal. By constructing the PB element such that the LC azimuthal angle distribution follows a linear profile, the PBD can work as a high-efficiency single-order phase grating yielding a deflection angle θ=arcsin(2λ/P), where λ is the wavelength and P is the period of the PB profile. Detailed design and fabrication process of an PBD can be found in Y. H. Lee, et al., “Recent progress in Pancharatnam-Berry phase optical elements and the applications for virtual/augmented realities,” Opt. Data Process. Storage 3(1), 79-88 (2017), the entire contents of which are incorporated herein by reference.

Alternatively, an SBD 750 can be implemented by using a combination of cholesteric LC and polymer microgratings where dual frequency cholesteric liquid crystal may be used to accelerate the switching from the homeotropic state back to the planar state. Besides LC-based beam steering methods, beam deflectors based on electro-mechanical movements or micro-electro-mechanical systems (MEMS) can also be used. One example of a commercially available beam steering device is the MR-15-30 or TP-12-16 by Optotune (Dietikon, Switzerland) used in reflection mode or in transmission mode. Another alternative SBD 750 device that me be used in devices of the present invention is a digital mirror array (DMD) wildly available through Texas Instruments. The schematic layout of FIG. 7B with a transmissive SBD 750 can be readily adapted to use with a reflective SBD 750.

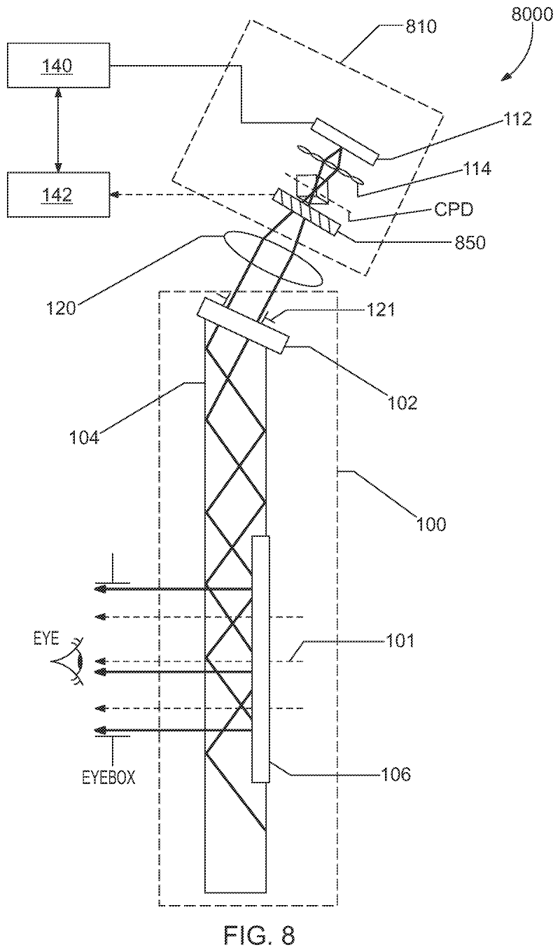

FIG. 8 shows the schematic layout of an exemplary optical see-through head-mounted lightfield display 8000 based on a lightguide or waveguide optical combiner 100 in accordance with the present invention, where the lightfield rendering unit 810 is modified to incorporate a NA expander unit 850 inserted near the central depth plane in order to enhance the effective view density of the reconstructed lightfield outcoupled by a substrate-guided optical combiner. The embodiments of the NA expander 850 can be in various diffusing materials, configurations and structures as shown in the examples of FIGS. 4-7. If the NA expander 850 is either motorized (FIG. 5) or electrically switchable between different layers (FIG. 6) or different states (FIGS. 4 & 7), a controller 142 may be required to provide electrical control to the NA expander 850 and controller 142. In this case, the state of the NA expander 850 (e.g. its motorized position, or its switch of layers, or its switch of transparency or diffusion properties, or switch to different deflection angles) may also be synchronized through a controller 142 and a computer 140 with the rendering of the display engine. The controller 142 may contain function generators or similar devices alike to generate the waveforms (e.g. square waves of a few hundreds or thousands of Hz to control the switch of different states or triangular waveform to control the linear scanning motion of motorized stage) required for driving the NA expander 850. The clock of the controller 142 that controls the temporal characteristics of the signal controlling the NA expander 850 may be synchronized with the clock of a computer 140 which controls the rendering the displayed content. The controller 142 may also just produce a simple electrical field (such as a voltage or current) to drive the motion of a stage or control the angle of the NA expander 850 and contain a detector that measures the position of the stage. The detected signal may be sent to a computer 140 to be synchronized with the rendering of the displayed content. Overall, the controller 142 usually depends on the operating principles of the NA expander devices and may be obtained from the vendors of the devices.

Finally, the use of a NA expander 450, 650, 750, 850 in accordance with the present invention to expand the effective NA of the elemental views rendered by an InI unit 110, 400, 500 can also be beneficial in InI-based lightfield display systems that do not utilize a substrate-guided optical combiner, although it was motivated to address some of the issues associated with substrate-guided optical combiners. For instance, the physical array arrangement of the MLAs or other optics arrays utilized in InI-based lightfield systems can impose the physical limit to the fill factor of the elemental views and thus limit the ultimate resolution and depth of field of the reconstructed lightfield in any InI-based display systems, either immersive or using optical see-through. Therefore, the proposed use of a NA expander may be readily applicable to any InI-based display engines.

### Characterizing Image Performance of a LF-HMD System Based on Substrate-Guided Optical Combiner

Based on the devices and methods in accordance with the present invention described above, a micro-InI 110, 400, 500 unit can be adapted with a substrate-guided optical combiner 200 to enable a compact lightfield display by effectively increasing the fill factor of the elemental views. On the other hand, considering the tradeoffs between the effective viewing density of the out-coupled lightfield image and the image artifacts induced by the ray path splitting by the substrate and outcoupler, we anticipate that the choice of the NA expander plays a critical role in image performance and an optimal P_{fp} should be selected.

By adopting the modeling and retinal image simulation methods we developed for MMA-based lightguides, we investigated the out-coupled image performance of an InI-based LF-HMD using a MMA-based lightguide where different footprint fill factors P_{fp} were investigated and guidelines for an optimal choice of NAₑ and its resulted P_{fp}.

For the purpose of simulation, we used a 0.61″ monochrome organic light emitting display (OLED) by MicroOLED (Grenoble Cedex 9, France) which offered a pixel size of a 4.7 um and an active resolution up to 2600×2088 pixels. In our simulation, only 1485 by 892 pixels were used. The MLA 114 was custom-designed for the project in H. Huang and H. Hua, “High-performance integral-imaging-based lightfield augmented reality display using freeform optics,” Opt. Express 26(13), 17578-17590 (2018), the entire contents of which are incorporated herein by reference. The MLA had a pitch size of 1 mm and an f-number of 3.3. The lateral magnification M_{MLA} of a lenslet in the MLA was 3, which gave the rendered scene with 3 by 3 views. One may also find commercially available MLA's from Thorlabs (Newton, N.J., USA) or other vendors with different specifications. The image collimator 120 had a focal length of 20.82 mm, which gave a FOV of 19.11°×11.49°. The in-coupling surface of the MMA lightguide was located at the back focal distance of the collimator, which coincided with the exit pupil of the collimator. The lightguide had a dimension of 51 mm (L)×4.39 mm (W)×16 mm (H), with an in-coupler wedge surface width of 13.42 mm and an MMA out-coupler area of 13.3 mm (L)×1.53 mm (W)×16 mm (H). Both of the collimator and the lightguide were dismounted from a commercially available system Model: ORA-2 made by Optinvent (Monte Sereno, Calif., USA). The CDP of the reconstructed lightfield after the collimator was located at 0.6 diopters from the eye pupil in the visual space, and a 3D scene was rendered on the CDP in the simulation. The eyebox was located 23 mm away from the inner surface of the lightguide, with a circular shape of 4 mm in diameter. The choice of these parameters was based on available parts for prototype implementation. Similar parts with different specifications can be used to substitute entirely or partially.

The simulation was done in LightTools® (Synopsis Inc, Mountain View, Calif., USA) by setting up the lightguide model and tracing each elemental ray bundle from a pixel on the microdisplay of the InI-engine. The simulation method has been discussed in detail in M. Xu and H. Hua, “Finite-depth and varifocal head-mounted display based on geometrical lightguide,” Opt. Express 28(8), 12121-12137 (2020). For simplicity, we only simulated the three elemental views in YOZ plane, since the elemental views in the XOZ plane experienced similar ray paths and had similar image performances. The data of each elemental ray bundle hitting on the eyebox was iteratively collected, including the number of ray paths, ray positions and directional cosines of the rays for further image reconstruction and performance evaluation. To compare the image performance and efficiencies for InI-engines of different fill factors, the beam width of the in-coupling elemental ray bundle was altered in accordance with the emitting angles of different NA expanders. Table 1 summarized the half emitting angles θ, the corresponding footprint diameters dₑ on the lightguide in-coupler wedge, and the footprint fill factors P_{fp} of all the simulated cases.

TABLE 1
Selected NA expansion conditions and fill factors
on reconstruction plane in simulations.

| Half emitting angle θ | dₑ | P_{fp} |
|---|---|---|
| No NA expansion | 1.58 mm | 1 |

| | | | |
|---|---|---|---|
| 3 | degree | 2.18 mm | 1.38 |
| 5 | degree | 3.64 mm | 2.31 |
| 8 | degree | 5.85 mm | 3.71 |
| 10 | degree | 7.34 mm | 4.66 |
| 12 | degree | 8.85 mm | 5.61 |
| 15 | degree | 11.16 mm | 7.07 |

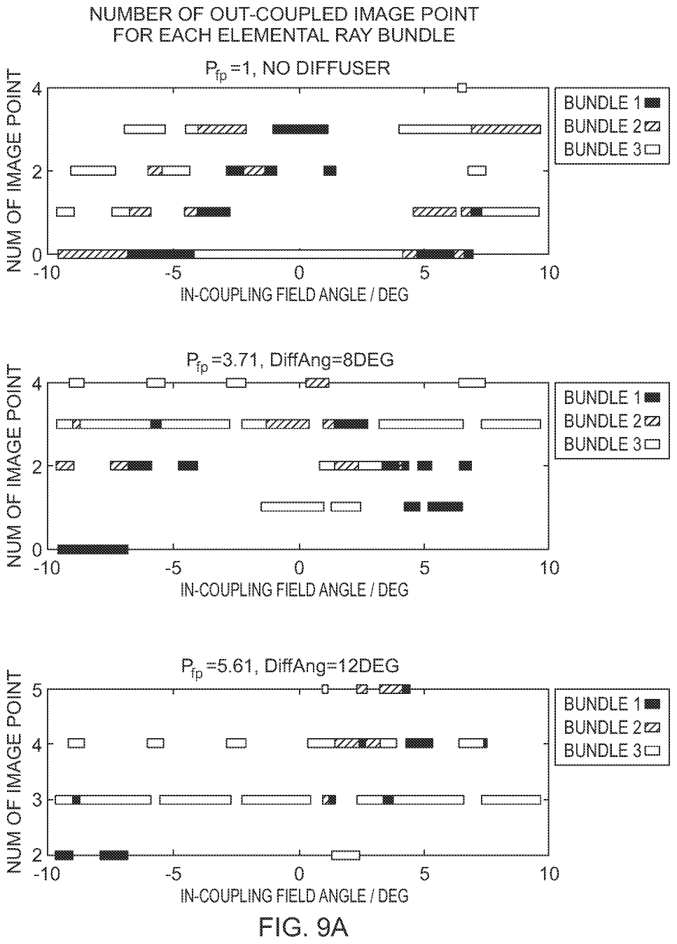

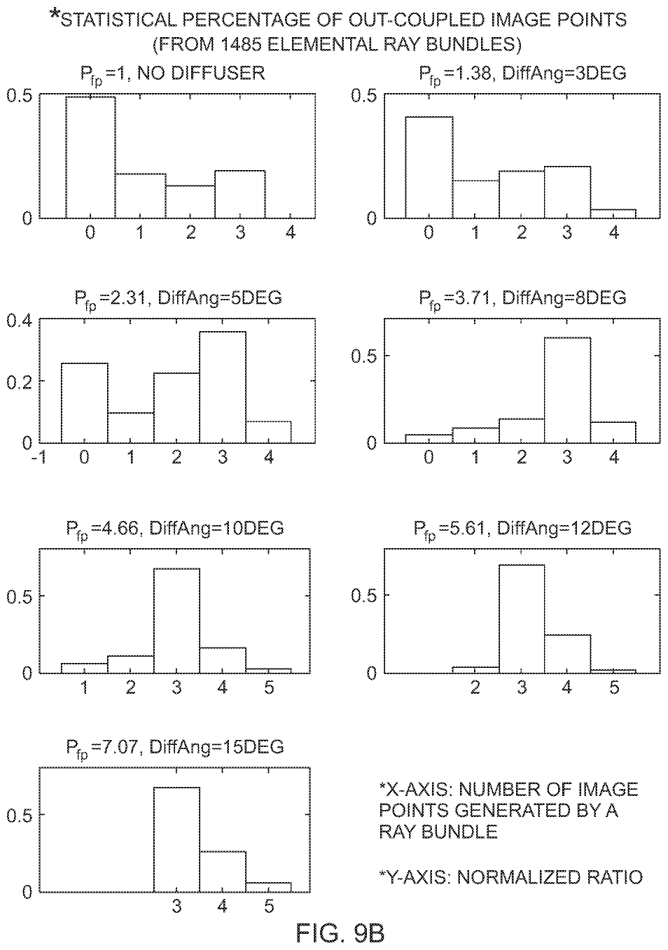

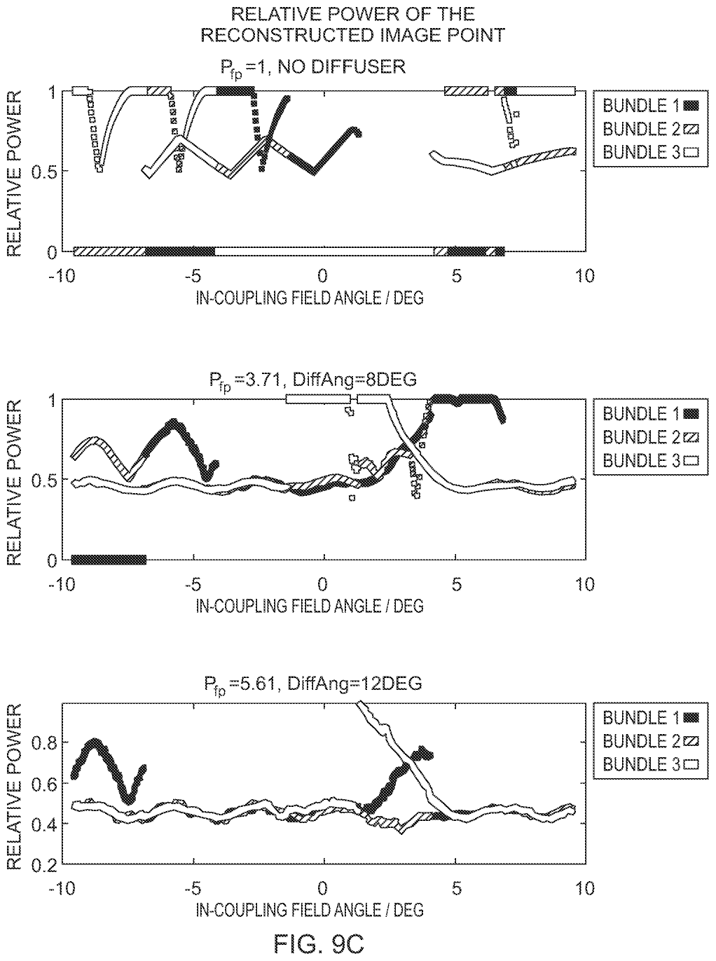

FIGS. 9A-9C summarize the main simulation results charactering the effects of different footprint fill factors in InI-based MMA lightguide system. The in-coupling field angle θᵢ, which is labeled in FIG. 3, is defined as the angular position of an image point from the reconstruction plane to the center of collimator. The number of image points or ray paths nᵣ originated from each elemental ray bundle coupling through the eyebox was plotted in FIG. 9A to estimate where the ghost-like image artifact or the elemental view missing arises at θᵢ. The data of the three elemental ray bundles rendering three elemental views of each 3D image point in the YOZ plane are labeled as solid, hashed and empty in the figure, respectively, which counts for the number of ray paths originated from the lower, middle, and upper elemental ray bundles in FIG. 4, respectively. Each ray path will reconstruct an image point seen by the viewer. Since an elemental ray bundle may be split into multiple ray paths and generate multiple image points due to the ray path splitting, the image point generated by the ray path with the highest optical power in a ray bundle is the primary image point, and all the other image points are ghost image points. In this case, the reconstructed 3D scene will be free of image artifacts if nᵣ=1 for all elemental ray bundles, while the elemental view will suffer ghost-like image artifact if nᵣ≥2; or the elemental view will be totally missing if nᵣ=0 for a specific elemental ray bundle. The simulated results of nᵣ as a function of in-coupling field angle θᵢ under three NA expansion conditions when P_{fp} equals 1, 3.71 and 5.61 are shown in FIG. 9A. It can be seen that when there is no NA expander (P_{fp}=1), the EIs from +1.2° to +4.2° are totally missing, since no elemental image is able to be coupled out at these fields; while these elemental images are able to be coupled out if P_{fp} is 3.71 or 5.61. FIG. 9B plots a normalized statistical distribution of the number of ray paths nᵣ from all 1485 elemental ray bundles when the footprint fill factor varies from 1 to 7.07. The results show that there is a trade off between the two aforementioned artifacts. Some of the elemental views are missing (nᵣ=0) when P_{fp}≤3.71, while the percentage of image ghost increases as the fill factor increases. FIG. 9C plots the power ratio of the primary image point to the overall out-coupled elemental ray bundle, when P_{fp} equals 1, 3.71 and 5.61. It is also shown that as P_{fp} increases, the missed EIs from +1.2° to +4.2° are able to be coupled out, but more optical power may be turn into the ghost-image points, which can cause image contrast degradation.

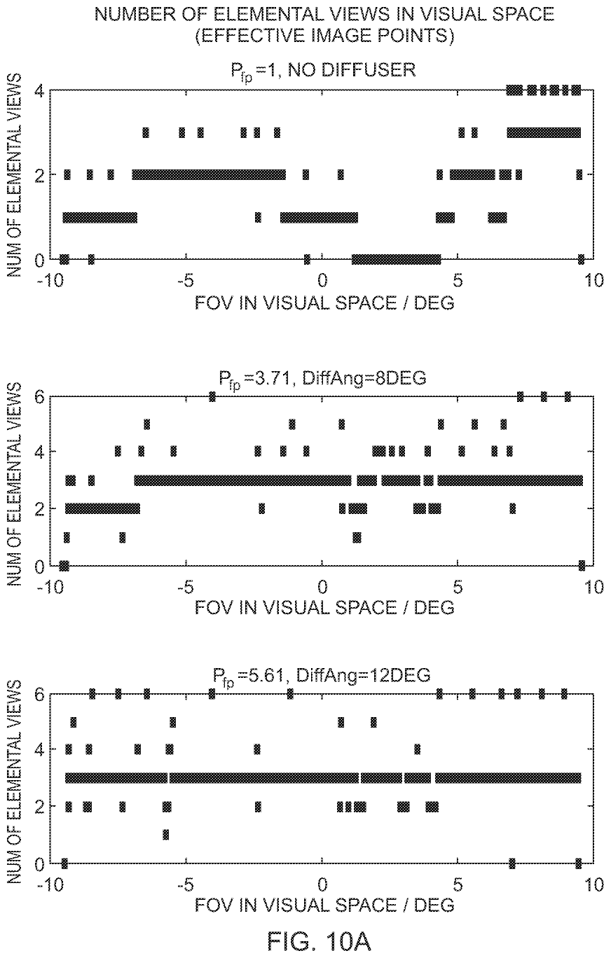

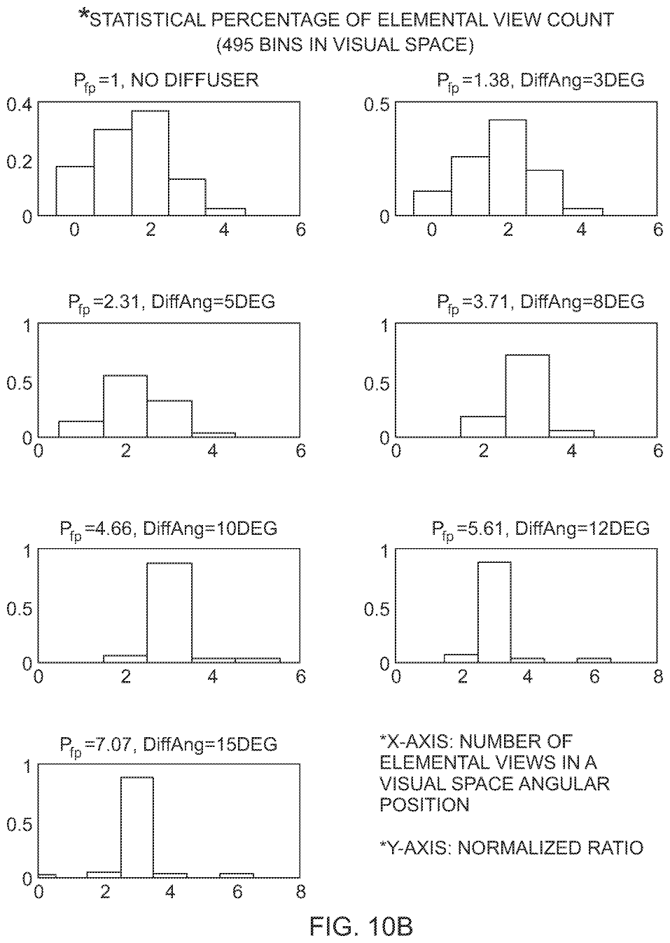

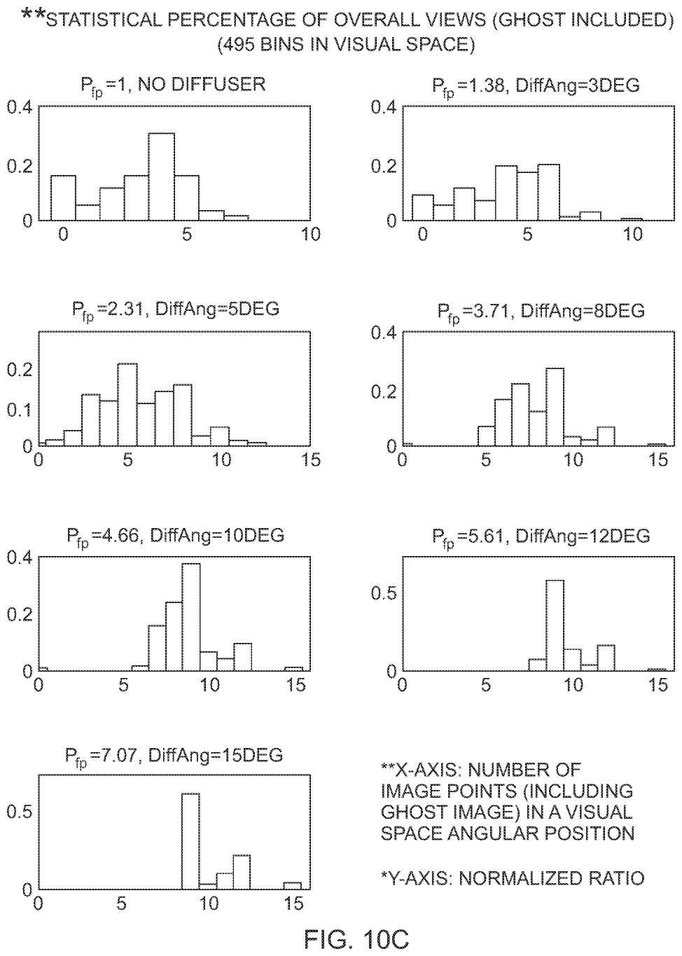

To evaluate the image performance of the actual out-coupled lightfields, we also simulated the distribution of the reconstructed image points as a function of FOV in visual space. The whole FOV in the YOZ direction was divided by 2.3 arcmins per bin to collect the elemental views, where the sampling density of 2.3 arcmins is consistent with the angular resolution of the reconstructed image in visual space. FIG. 10A plots the number of elemental views that are actually coupled out through the eyebox, determined by each of the sampling bin, as the primary image points in visual space when P_{fp} equals 1, 3.71 and 5.61, which represents the angular distributions of the out-coupled elemental views despite of ghost images. The results also show that the image between +1.2° to +4.2° cannot be coupled out from the lightguide when there is no NA expansion (P_{fp}=1), while as P_{fp} increases, more elemental views can be coupled out. The normalized statistical distributions of the number of the primary image point in visual space when P_{fp} changes from 1 to 7.07 are plotted in FIG. 10B, which gives the statistical results of FIG. 10A under different P_{fp}. It is seen that when P_{fp} is larger than 3.71, all the viewing directions across the FOV have at least 2 elemental views, which satisfies the minimal condition of rendering the depth cues of a 3D scene with at least 2 elemental views in InI-based lightfield displays. FIG. 10C plots the distributions of the overall out-coupled image points including the ghost image points generated by ray path splitting, showing that more ghost images can be observed as the P_{fp} increases, which affects the image contrast.

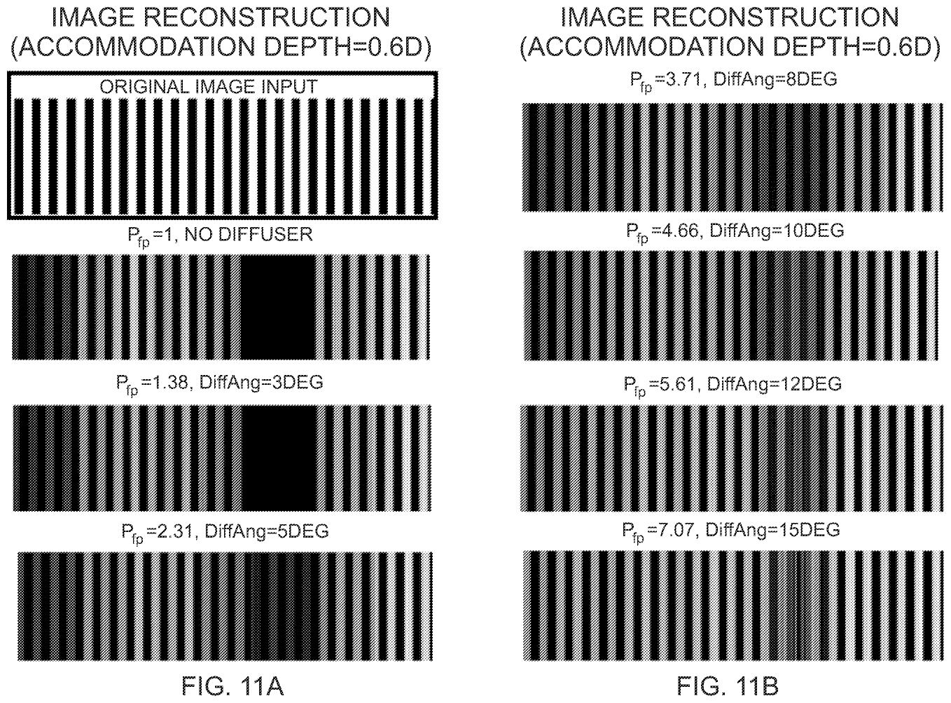

Based on the ray tracing method, the retinal image of an InI-based MMA lightguide system can also be reconstructed. The method of reconstructing the retinal image of a MMA lightguide system has been discussed in M. Xu and H. Hua, “Methods of optimizing and evaluating geometrical lightguides with microstructure mirrors for augmented reality displays,” Opt. Express 27(4), 5523-5543 (2019), the entire contents of which are incorporated herein by reference. The incoherent retinal point spread function (PSF) of each image point including ghost image point was simulated based on the collected ray path data. The Arizona Eye Model was adopted to simulate the optical performance of the human eyes. (Schwiegerling J. Field Guide to Visual and Ophthalmic Optics, Bellingham, Wash.: SPIE Press, 2004, the entire contents of which are incorporated herein by reference.) Diffraction effects introduced by the pupil function and field-dependent pupil transmittance were also considered. A sinusoid fringe pattern with a spatial frequency of 0.77 cy/deg was employed as the test image and is shown in FIG. 11A. The test image is rendered on the CDP, which is at 0.6 diopters away in visual space. The simulated retinal images under different fill factors P_{fp} were shown in FIG. 11B, by convolving the original image with the field-dependent PSFs. It is shown that as the fill factor increases, the image uniformity improves significantly, though some ghost images caused by the ray path splitting and image contrast degradation can be observed.

### Experimental Results

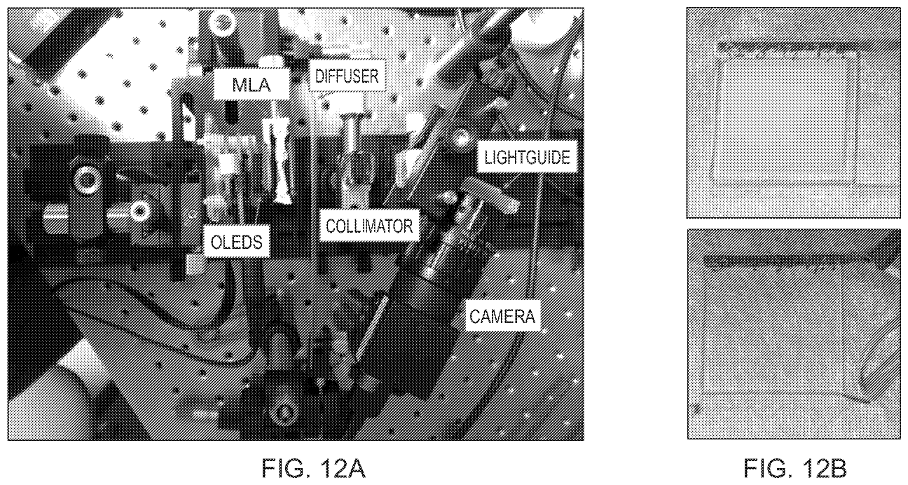

Based on the schematics in FIG. 8, we implemented a proof-of-concept prototype of an InI-based MMA lightguide system in accordance with the present invention as shown in FIG. 12A. We used a monochromatic OLED microdisplay and an existing MLA to construct the InI-engine; a commercial objective as the image collimator 120; and, a MMA lightguide as the optical combiner. The system specifications and setups were the same as those used in the simulation described above. To increase the footprint fill factor P_{fp}, engineered diffusers or PDLCs (FIG. 12B) with certain diffusing angles were inserted on the CDP plane. A machine vision camera was set at the exit pupil of the lightguide to capture the out-coupled image.

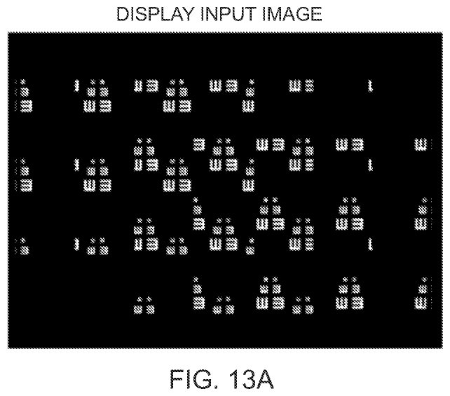

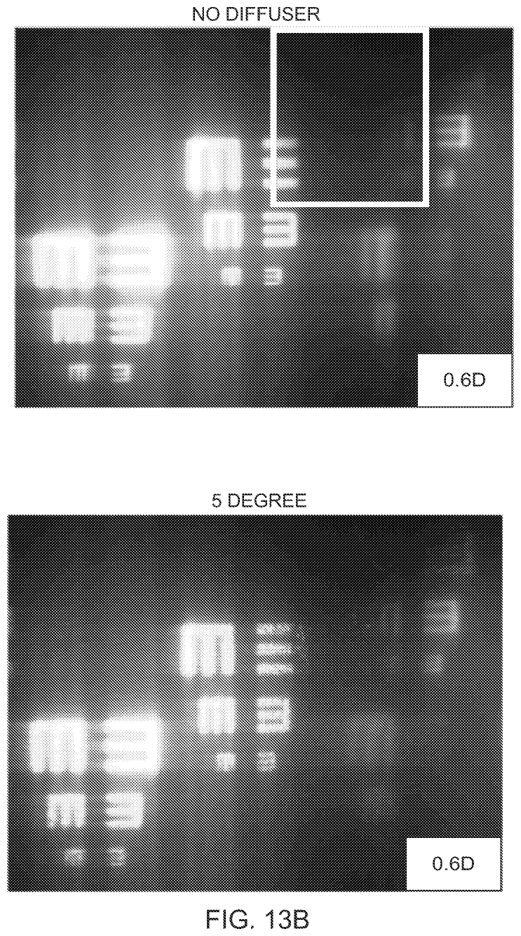

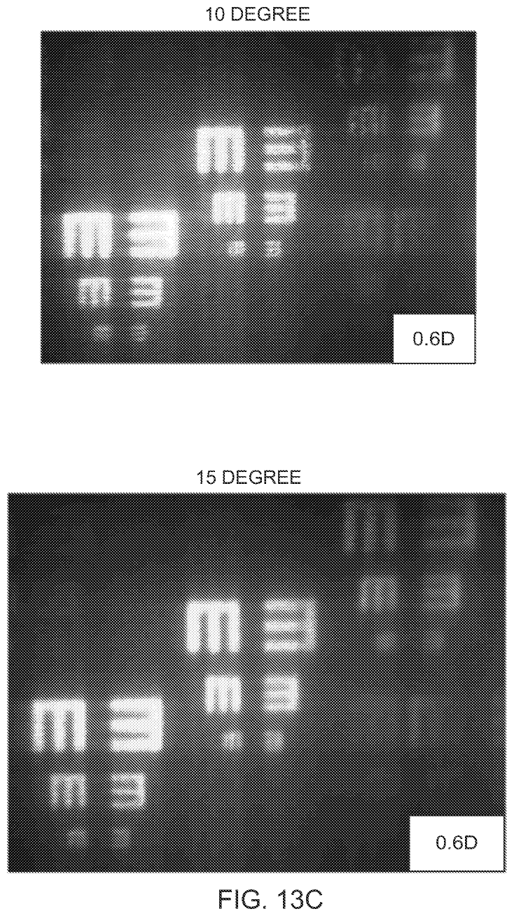

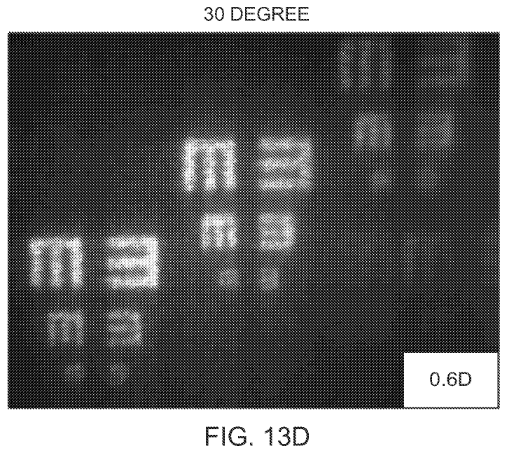

The first scene was rendered on the CDP, which conjugated to 0.6 diopters in visual space. Three groups of Snellen letter ‘E’s with the same depth were rendered at 0.6 diopters. The angular resolutions of the Snellen letters were 0.63, 0.42 and 0.21 degrees/cycle (top to bottom) in visual space, corresponding to 3, 2, and 1 pixels of line width of the letters. FIG. 13A shows the displayed elemental views rendered on the microdisplay. The elemental views were then integrated by the MLA and the 3D scene was reconstructed via the collimator apparently located at the depth of 0.6 diopters from the camera. The reconstructed lightfield of the scene is then coupled through the MMA lightguide. Figured 13B-13D show the captured out-coupled image from the InI-LG when no diffuser was inserted, or an engineered diffuser with its full width half maximum (FWHM) diffusing angle of 5, 10, 15 or 30 degrees was inserted, respectively. The engineering diffusers were light shaping diffusers made by Lumnit (St. Torrance, Calif., USA). The camera exposure and aperture were kept unchanged during the capturing. As shown by the image captured without a diffuser, there was a dark region caused by an elemental view missing on the right side of the captured image without the diffuser (shown in the white rectangle). As the diffusing angle increased, this missing region marked by the white box began to be coupled out, and the overall image uniformity significantly improved, while the overall image became dimmer, FIG. 13C. Some punctate artifacts could also be observed from the images captured with diffusers, which was induced by the irregular structures of the engineered diffusers. The results validated that the NA expansion scheme could help the elemental views to be coupled out and improve the out-coupling uniformity over FOV.

To study the rendering performance of the InI-engine in a wide depth range, the second scene was rendered with the same three groups of Snellen letters but each group was located at different reconstruction depths, corresponding to 0.01, 0.6 and 3 diopters respectively, (from top-right to bottom-left). The engineered diffuser was replaced by multi-layer-stacking PDLCs (ML-PDLCs) as the NA expander for the reconstructed 3D images at different depths. The transparency of each layer in the ML-PDLCs could be electrically driven in very fast speed, so that the diffusing depth could be switched between different depths, each approximately matching with the depth of a desired reconstruction target plane. It is worth noting that the collimator needed to be moved closer to the InI-engine when inserting a PDLC with a glass substrate to compensate for the reduced equivalent air thickness of the substrate. As a comparison, we selected two commercial ML-PDLCs with different specifications as the NA expander, which were named as MP1 (from Kent Optronics) and MP2 (from LightSpace Technologies), respectively. Table 2 lists the specifications of the two ML-PDLCs.

TABLE 2
Optical properties and specifications of ML-PDLCs.

| | Num. of | Diffusing | Transmittance | | Switch |
|---|---|---|---|---|---|
| | layers | angle | (1 layer in | Layer | speed |
| Name | (nₗ) | (FWHM θ_{d}) | diffusing state) | Separation (L) | (t) |
| MP1 | 2 | 41°-43° | 2.2% | 1.45 mm | NA |
| MP2 | 3 | 20° | 35% | 1.2 mm | <1 ms |

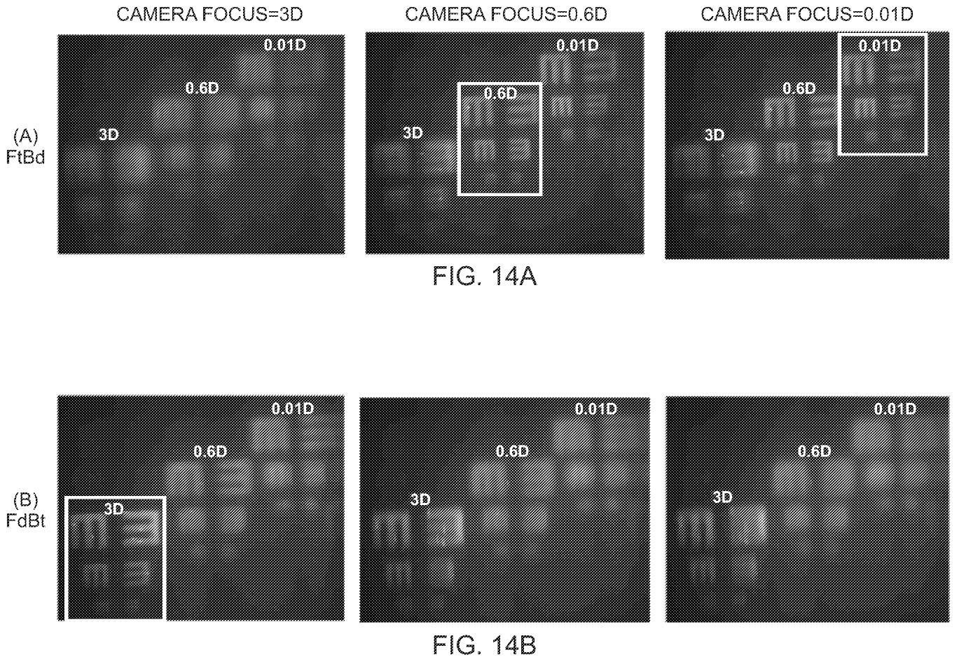

To compare the optical performances of MP1 and MP2, only two adjacent layers of MP2 were used, while the third layer was kept in transparent state. During the experiments, the back layer of the MP1 or MP2, which was the layer further from a viewer, was placed at the CDP for diffusing distant objects, while the front layer (the layer closer to viewer) was placed at the depth of the near scenes. FIGS. 14A, 14B show the results of the InI-engine with MP1 as the NA expander. To compare the image performance and focus cues when the diffusing plane is at different depths, we captured the images when the back layer was in a diffusing state and the front layer was in a transparent state (FtBd in FIG. 14A) or vice versa (FdBt in FIG. 14B). The targets rendered at 0.01 and 0.6 diopters were closer to the back PDLC layer, while the target of the 3-diopters depth was closer to the front PDLC layer in the dioptric space. The camera focus was also changed in accordance with the depth of the three targets. It can be seen that the targets look much sharper when their depths approximately match with the depths of the corresponding diffusing screen and camera focus. Due to the low transmittance and large diffusing angle of MP1, the captured images were much dimmer compared with the image without ML-PDLC, but all of the elemental view were all coupled out and the field uniformity of the captured images were much improved. Besides, the lateral displacement between elemental images when the camera focus moved away from the reconstructed image plane were less visible, and the defocus blur became much more natural compared with a conventional InI-engine. The results show that the correct depth cues were rendered when the depth of the diffusing screen was placed near the rendering depth.

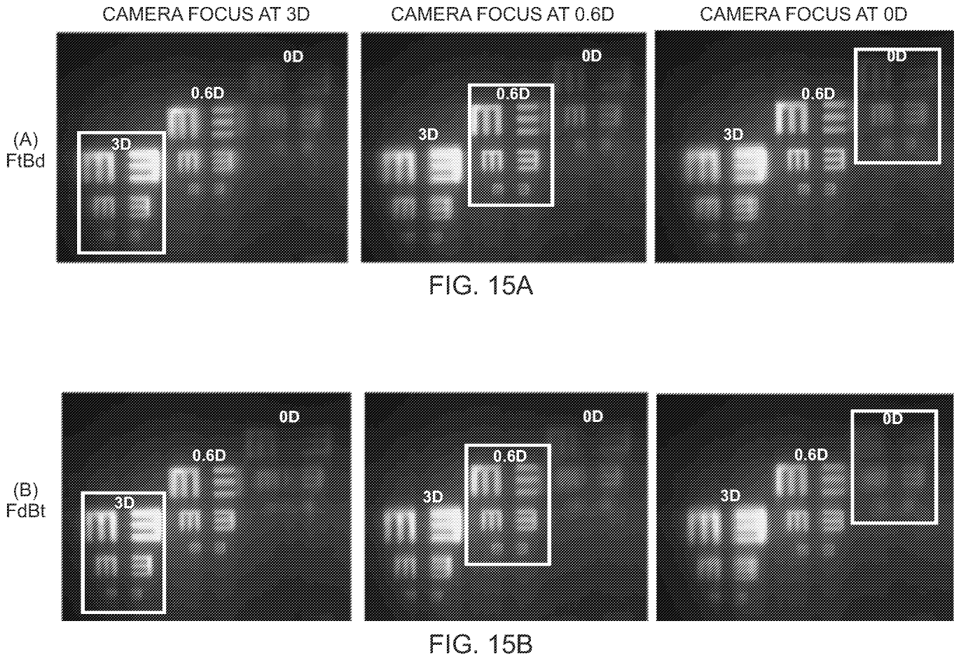

FIGS. 15A, 15B show the results of the InI-engine with MP2 as the NA expander, when the back layer (FIG. 15A) or the front layer (FIG. 15B) was turned into diffusing state, respectively. The overall image coupling efficiency was much higher compared with the results shown in FIGS. 14A, 14B (camera exposure time in FIGS. 14A, 14B was more than ten times longer than that used in FIGS. 15A, 15B), because of the higher transmittance and narrower diffusing angle of MP2, as shown in Table 2. However, the field uniformity was not as good as the results shown in FIGS. 14A, 14B due to the narrower diffusing angle. In addition, the depth cues were less sensitive to the location of the diffusing screen; they relied more on the rendering depth of the InI-engine, when comparing the results in FIGS. 15A and 15B. It is worth noting that the image depth in visual space may change due to different OPDs coupling through different field angles, which may induce depth errors in visual space.

In a summary, the optical performance of an InI-LG system in accordance with the present invention depends on the optical properties of the NA expander. When adapting an InI-engine to the lightguide-based OST-HMD, the diffusing angle and the position of the NA expander are two major factors determining the image quality and implementation of the InI-LG. The diffusing angle determines the footprint fill factor P_{fp} of each EI, which affects the uniformity and efficiency of the out-coupled image. When the diffusing angle of the NA expander increases, the increased P_{fp} gives EIs more possibilities to be coupled out, while the chances of a larger portion of the ray bundles from EIs that are lost through the lightguide also increase. In this case, the out-coupled image becomes much more uniform at the cost of image coupling efficiency. On the other hand, the diffusing angle can also affect the positional sensitivity of the NA expander. When the diffusing angle is large so that the projected beam size on the reconstructed image plane is much larger than the original beam size of elemental ray bundles, the image quality is more sensitive to the location of PDLC because of the shallower depth of fields. In this case, stacking ML-PDLC should be adopted as the NA-expander, because the position of NA expansion becomes the dominant factor affecting reconstructed angular resolution of the InI-engine, rather than the depth displacement between the reconstructed image plane and CDP. On the contrary, when the PDLC has a narrower diffusing angle and high transmittance, one PDLC layer with a fixed position is enough to display a 3D scene over a wide depth range, since the depth of field are extended and image quality is less sensitive to the PDLC position. In the meantime, the image uniformity will get worse due to a narrower diffusing angle, which has also been proven by the results shown in FIGS. 14A-15B.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A head-mounted lightfield display, comprising:
a lightfield rendering unit having microdisplay and a central depth plane (CDP) disposed at a location optically conjugate to the microdisplay to provide an output optical lightfield centered at the CDP;
a numerical aperture (NA) expander disposed at or proximate the CDP to receive the output optical lightfield and transmit the output optical lightfield therethrough to provide an expanded lightfield at an output of the NA expander; and
a substrate-guided optical combiner optically coupled to the NA expander and configured to receive the expanded lightfield and configured to transmit the expanded light field to an output thereof for viewing by a user.

2. The head-mounted lightfield display of claim 1, wherein the lightfield rendering unit comprises an integral-imaging-based lightfield display engine.

3. The head-mounted lightfield display of claim 1, wherein the lightfield rendering unit includes a micro-lenslet array (MLA) disposed between the microdisplay and the CDP, the MLA configured to make the microdisplay optically conjugate to the CDP.

4. The head-mounted lightfield display of claim 1, wherein the NA expander includes a diffuser.

5. The head-mounted lightfield display of claim 1, wherein the NA expander includes one or more of a holographic optical element, a diffractive optical element, and a polymer dispersed liquid crystal.

6. The head-mounted lightfield display of claim 1, wherein the NA expander is switchable.

7. The head-mounted lightfield display of claim 1, wherein the NA expander is movably disposed at the CDP.

8. The head-mounted lightfield display of claim 1, wherein the NA expander is fixedly disposed at the CDP.

9. The head-mounted lightfield display of claim 1, wherein the NA expander comprises a plurality of stacked diffusers.

10. The head-mounted lightfield display of claim 1, wherein the NA expander comprises a switchable beam deflector.

11. The head-mounted lightfield display of claim 1, wherein the NA expander comprises a Pancharatnam-Berry phase deflector.

12. The head-mounted lightfield display of claim 1, comprising a collimator disposed between the NA expander and the substrate-guided optical combiner to transmit the expanded lightfield from the NA expander to an input of the substrate-guided optical combiner.

13. The head-mounted lightfield display of claim 12, wherein collimator is configured to magnify the output optical lightfield and image the output optical lightfield scene into visual space.

14. The head-mounted lightfield display of claim 12, wherein the microdisplay emits a cone of light from a selected point and wherein the NA expander receives the cone of light to provide an expanded cone of light to the collimator, the expanded cone of light having a footprint expanded diameter, dₑ, in a plane of an exit pupil of the collimator, wherein
$${d}_{e} = \frac{2 {NA}_{e} \cdot {z}_{0}}{{z}^{′}} \cdot ( {z}^{′} + {z}_{LG} ) ,$$
where
z₀ is the distance from the collimator to the CDP, z′ is the distance from the collimator to a virtual CDP in visual space, and z_{LG} is the distance from the collimator to the plane of the exit pupil, and z_{LG} equals a focal length of the collimator, and where NAₑ=tan θ, and θ is the half emitting angle of each elemental view after passing through the NA expander.

15. The head-mounted lightfield display of claim 1, wherein the output optical lightfield comprises a reconstructed 3D volume.

16. The head-mounted lightfield display of claim 1, wherein the substrate-guided optical combiner includes an in-coupler, a guiding substrate and an out-coupler.

17. The head-mounted lightfield display of claim 16, wherein one or more of the in-coupler and the out-coupler may be one or more of a diffractive optical element (DoE), a holographic optical element (HoE), a reflective or partially reflective optical element (RoE), and a refractive element.
